(19) United States
(12) Patent Application Publication
(10) Pub. No.: US 2006/0100824 A1
(43) Pub. Date: May 11, 2006

(54) Plasma processing apparatus, abnormal discharge detecting method for the same, program for implementing the method, and storage medium storing the program

(75) Inventor: Tsuyoshi Moriya, Nirasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/259,038

(22) Filed: Oct. 27, 2005

Related U.S. Application Data
(60) Provisional application No. 60/626,467, filed on Nov. 10, 2004.

(30) Foreign Application Priority Data
Oct. 27, 2004 (JP) JP 2004-312689

(51) Int. Cl. G21C 17/00; G06F 19/00

(52) U.S. Cl. 702/183; 702/57

(57) ABSTRACT

A plasma processing apparatus that is capable of accurately detecting abnormal discharge. A chamber 10 houses a semiconductor wafer W. A susceptor 11 which functions as a lower electrode and a showerhead 33 which functions as an upper electrode are disposed inside the chamber 10, for applying a high-frequency electric power inside the chamber 10. Processing gas supply piping 38 introduces a processing gas into the chamber 10. A potential probe 50 detects fluctuations in potential. An ultrasonic sensor 41 detects ultrasonic waves. A CPU of a PC 52 determines that abnormal discharge has occurred when both the fluctuations in potential and the ultrasonic waves are detected in the same timing.

### BACKGROUND OF THE INVENTION

1. Field of the Invention

The present invention relates to a plasma processing apparatus which is capable of detecting an abnormal discharge, an abnormal discharge detecting method for the same, a program for implementing the method, and a storage medium storing the program.

2. Description of the Related Art

A plasma processing apparatus that carries out predetermined plasma processing on a substrate such as a semiconductor wafer or a flat display panel generally includes a chamber for housing the substrate. The plasma processing apparatus operates such that a processing gas is introduced into the chamber and high-frequency electric power is applied inside the chamber to produce plasma from the processing gas, with the produced plasma subjecting the substrate to plasma processing.

When the high-frequency electric power is applied inside the chamber, abnormal discharge such as arcing can occur due to a variety of factors. Such abnormal discharge damages the substrate and component elements disposed inside the chamber. More specifically, cracks, notches, and the like are produced in the surface of the semiconductor wafer used as the substrate or the component elements are burnt. The abnormal discharge can also detach deposits stuck to component elements inside the chamber, such as an upper electrode, thereby producing particles inside the chamber.

To prevent damage to the semiconductor wafer and component elements and also prevent the production of particles, it is necessary to readily detect abnormal discharge and stop the operation of the plasma processing apparatus when abnormal discharge is detected.

For this reason, methods that readily detect abnormal discharge have been conventionally developed. Examples of such methods include a method that monitors a value of current supplied from a power-feeding rod connected to one of the electrodes inside the chamber, and a method that monitors reflected waves of a high-frequency voltage reflected from the electrode, but such methods have poor sensitivity and in particular cannot detect minimal abnormal discharge with favorable sensitivity.

For this reason, a method that detects AE (acoustic emission), which is one phenomenon that occurs during abnormal discharge, has been developed in recent years. In this method, an ultrasonic sensor that detects ultrasonic waves based on the emission of energy due to AE during abnormal discharge is used.

Examples of apparatuses that use this method include an apparatus that is equipped with a plurality of ultrasonic sensors disposed on an outside wall of the chamber and detects ultrasonic waves due to the emission of energy during abnormal discharge using the ultrasonic sensors, and an apparatus (see, for example, Japanese Laid-Open Patent Publication (Kokai) No. 2003-100714) that is equipped with a plurality of acoustic probes, which are disposed in contact with a susceptor used as a mounting table on which a semiconductor wafer is mounted or with a focus ring disposed in the vicinity of the mounted semiconductor wafer, and an ultrasonic detector (ultrasonic sensor) that detects ultrasonic waves propagated from the acoustic probes, to thereby detect the ultrasonic waves. Note that in such apparatuses, the ultrasonic sensors detect the ultrasonic waves as signals.

However, since the ultrasonic sensors detect as signals not only ultrasonic waves due to AE during abnormal discharge but also noise caused by mechanical vibration due to a gate valve of the plasma processing apparatus opening and closing, it is difficult to accurately detect abnormal discharge. For this reason, it is necessary to distinguish whether the ultrasonic sensors have detected ultrasonic waves caused by abnormal discharge or have detected noise due to mechanical vibration. Since the frequency distributions were expected to differ for ultrasonic waves caused by abnormal discharge and for noise due to mechanical vibration, to distinguish between the noise and the ultrasonic waves, it was thought effective to analyze the frequencies of the signals detected by the ultrasonic sensors.

However, from experiments conducted by the present inventor in recent years, it has turned out that the frequency distribution of ultrasonic waves caused by abnormal discharge changes according to the position in the plasma processing apparatus where abnormal discharge occurs. It is also expected that the frequency distribution of ultrasonic waves caused by abnormal discharge will differ between individual plasma processing apparatuses.

Accordingly, it is difficult to distinguish from frequency analysis of the signal detected by an ultrasonic sensor whether the ultrasonic sensor has detected ultrasonic waves caused by abnormal discharge or has detected noise due to mechanical vibration, and therefore it remains difficult to accurately detect abnormal discharge in a plasma processing apparatus.

### SUMMARY OF THE INVENTION

It is an object of the present invention to provide a plasma processing apparatus and an abnormal discharge detecting method for the same, that are capable of accurately detecting abnormal discharge, a program for implementing the method, and a storage medium storing the program.

To attain the above object, in a first aspect of the present invention, there is provided a plasma processing apparatus comprising a chamber that houses a substrate, at least one electrode that is disposed inside the chamber, for applying a high-frequency electric power inside the chamber, piping that introduces processing gas into the chamber, a potential fluctuation detecting device that detects fluctuations in potential, an ultrasonic detecting device that detects ultrasonic waves, and an abnormal discharge determining device operable when both the fluctuations in potential and the ultrasonic waves are detected in substantially the same timing, to determine that abnormal discharge has occurred.

According to the above construction, when both fluctuations in potential and ultrasonic waves are detected in substantially the same timing, it is determined that abnormal discharge has occurred. Here, fluctuations in potential do not occur due to noise caused by mechanical vibration. Therefore, it is possible to distinguish between detection of ultrasonic waves caused by abnormal discharge and detection of noise due to mechanical vibration, thus enabling accurate detection of abnormal discharge.

Preferably, the ultrasonic detecting device comprises a first ultrasonic detecting device disposed on a side surface of the piping, and a second ultrasonic detecting device disposed an outside wall of the chamber.

According to the above construction, since ultrasonic waves are detected on the side surface of the piping and the outside wall of the housing, the occurrence position of the abnormal discharge can be specified.

Preferably, the plasma processing apparatus further comprises a power supply rod that is connected to the electrode, for supplying the high-frequency electric power to the electrode, and the ultrasonic detecting device is provided on the power supply rod.

According to the above construction, since ultrasonic waves is detected at the power supply rod that supplies the high-frequency electric power to the electrode, abnormal discharge that occurs in the vicinity of the electrode can be detected.

Preferably, the potential fluctuation detecting device includes a high-frequency component removing device that removes high-frequency components of a voltage induced by the fluctuations in potential.

According to the above construction, since high-frequency components of a voltage induced by the detected fluctuations in potential are removed, it is possible to remove fluctuations in potential caused by factors unrelated to the plasma, and therefore abnormal discharge can be detected more accurately.

Preferably, the potential fluctuation detecting device and the ultrasonic detecting device are integrated.

According to the above construction, since the potential fluctuation detecting device and the ultrasonic waves detecting device are integrated, it is possible to detect the fluctuations in potential and the ultrasonic waves at the same position, and therefore abnormal discharge can be detected accurately.

To attain the above object, in a second aspect of the present invention, there is provided a plasma processing apparatus comprising a chamber that houses a substrate, at least one electrode that is disposed inside the chamber, for applying a high-frequency electric power inside the chamber, piping that introduces processing gas into the chamber, a light emission fluctuation detecting device that detects fluctuations in intensity of light emission inside the chamber, an ultrasonic detecting device that detects ultrasonic waves, and an abnormal discharge determining device operable when both the fluctuations in intensity of light emission and the ultrasonic waves are detected in substantially the same timing, to determine that abnormal discharge has occurred.

According to the above construction, when both fluctuations in the intensity of light emission inside the chamber and ultrasonic waves are detected in substantially the same timing, it is determined that abnormal discharge has occurred. Here, fluctuations in the intensity of light emission do not occur due to noise caused by mechanical vibration. Therefore, it is possible to distinguish between detection of ultrasonic waves caused by abnormal discharge and detection of noise due to mechanical vibration, thus enabling accurate detection of abnormal discharge.

Preferably, the light emission fluctuation detecting device detects fluctuations in total light emission intensity inside the chamber.

According to the above construction, since the light emission fluctuation detecting device detects fluctuations in total light emission intensity inside the chamber, the detection of fluctuations in the intensity of light emission can be carried out easily.

To attain the above object, in a third aspect of the present invention, there is provided an abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the method comprising a potential fluctuation detecting step of detecting fluctuations in potential, an ultrasonic detecting step of detecting ultrasonic waves, and an abnormal discharge determining step of determining that abnormal discharge has occurred when both the fluctuations in potential and the ultrasonic waves are detected in substantially the same timing.

To attain the above object, in a fourth aspect of the present invention, there is provided an abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the method comprising a light emission fluctuation detecting step of detecting fluctuations in intensity of light emission inside the chamber, an ultrasonic detecting step of detecting ultrasonic waves, and an abnormal discharge determining step of determining that abnormal discharge has occurred when both the fluctuations in intensity of light emission and the ultrasonic waves are detected in substantially the same timing.

To attain the above object, in a fifth aspect of the present invention, there is provided a program for causing a computer to implement an abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the program comprising a potential fluctuation detecting module for detecting fluctuations in potential, an ultrasonic detecting module for detecting ultrasonic waves, and an abnormal discharge determining module of determining that abnormal discharge has occurred when both the fluctuations in potential and the ultrasonic waves are detected in substantially the same timing.

To attain the above object, in a sixth aspect of the present invention, there is provided a program for causing a computer to implement an abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the program comprising a light emission fluctuation detecting module for detecting fluctuations in intensity of light emission inside the chamber, an ultrasonic detecting module for detecting ultrasonic waves, and an abnormal discharge determining module of determining that abnormal discharge has occurred when both the fluctuations in intensity of light emission and the ultrasonic waves are detected in substantially the same timing.

To attain the above object, in a seventh aspect of the present invention, there is provided a computer-readable storage medium storing a program for causing a computer to implement an abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the program comprising a potential fluctuation detecting module for detecting fluctuations in potential, an ultrasonic detecting module for detecting ultrasonic waves, and an abnormal discharge determining module of determining that abnormal discharge has occurred when both the fluctuations in potential and the ultrasonic waves are detected in substantially the same timing.

To attain the above object, in an eighth aspect of the present invention, there is provided a computer-readable storage medium storing a program for causing a computer to implement an abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the program comprising a light emission fluctuation detecting module for detecting fluctuations in intensity of light emission inside the chamber, an ultrasonic detecting module for detecting ultrasonic waves, and an abnormal discharge determining module of determining that abnormal discharge has occurred when both the fluctuations in intensity of light emission and the ultrasonic waves are detected in substantially the same timing.

The above and other objects, features, and advantages of the invention will become more apparent from the following detailed description taken in conjunction with the accompanying drawings.

### BRIEF DESCRIPTION OF THE DRAWINGS

FIG. 1 is a cross-sectional view schematically showing the construction of a plasma processing apparatus according to a first embodiment of the present invention;

FIG. 2 is a cross-sectional view schematically showing the construction of an ultrasonic sensor connected to the plasma processing apparatus shown in FIG. 1;

FIG. 3A is a graph showing the potential of a signal produced by converting background noise measured by the ultrasonic sensor shown in FIG. 2 when the plasma processing apparatus shown in FIG. 1 is in a steady state;

FIG. 3B is a graph showing the potential of a signal produced by converting ultrasonic waves caused by abnormal discharge that occurs in a piping insulator appearing in FIG. 1;

FIG. 3C is a graph showing the potential of a signal produced by converting noise due to mechanical vibration caused by opening and closing of a gate valve appearing in FIG. 1;

FIG. 4A is a graph showing a frequency distribution of ultrasonic waves caused by abnormal discharge measured by the ultrasonic sensor shown in FIG. 2;

FIG. 4B is a graph showing a frequency distribution of noise caused by mechanical vibration measured by the ultrasonic sensor shown in FIG. 2;

FIG. 5 is a view showing the arrangement of the ultrasonic sensor and a potential probe mounted on the plasma processing apparatus shown in FIG. 1;

FIG. 6A is a perspective view showing, in detail, a high-frequency power supply system appearing in FIG. 5;

FIG. 6B is a cross-sectional view taken along line VI-VI in FIG. 6A;

FIG. 7 is a cross-sectional view showing, in detail, the construction of the potential probe appearing in FIG. 5;

FIG. 8 is a flowchart showing the procedure of an abnormal discharge detecting process carried out by a CPU of a personal computer (PC) appearing in FIG. 5;

FIG. 9 is a cross-sectional view schematically showing the construction of an integrated abnormal discharge detecting unit in which the ultrasonic sensor and the potential probe appearing in FIG. 5 are integrated;

FIG. 10 is a view showing the arrangement of an ultrasonic sensor and a light emission monitor mounted on a plasma processing apparatus according to a second embodiment of the present invention;

FIG. 11A is a graph showing the intensity of signals converted from plasma emission light picked up by the light emission monitor shown in FIG. 10 when the plasma processing apparatus is in a steady state;

FIG. 11B is a graph showing the intensity of signals converted from the plasma emission light when abnormal discharge occurs;

FIG. 12 is a flowchart showing the procedure of an abnormal discharge detecting process carried out by a CPU of the PC appearing in FIG. 10.

FIG. 13 is a graph showing the relationship between signals for fluctuations in potential and ultrasonic waves detected during etching processing by the plasma processing apparatus shown in FIG. 2 and timing in which arcing occurs; and

FIG. 14 is a graph showing the potential of a signal produced by converting ultrasonic waves caused by abnormal discharge that has occurred inside the chamber appearing in FIG. 1.

### DETAILED DESCRIPTION OF THE PREFERRED EMBODIMENTS

The present invention will now be described in detail below with reference to the drawings showing preferred embodiments thereof.

First, a plasma processing apparatus and an abnormal discharge detecting method for the same according to a first embodiment of the present invention will be described.

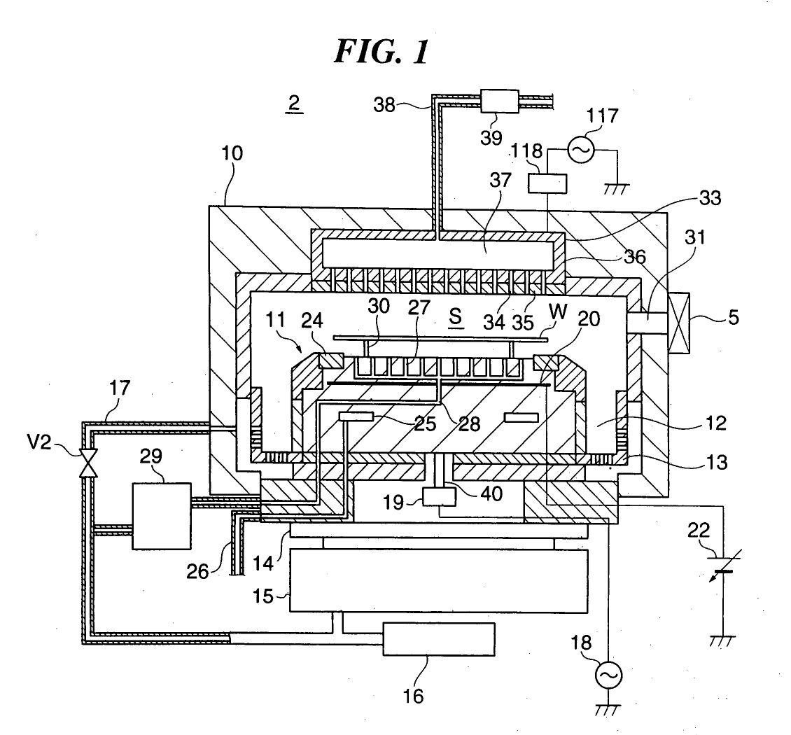

FIG. 1 is a cross-sectional view schematically showing the construction of the plasma processing apparatus according to the first embodiment of the present invention.

In FIG. 1, a plasma processing apparatus 2 that carries out an etching process on a semiconductor wafer includes a cylindrical chamber 10 made of metal, such as aluminum or stainless steel. A cylindrical susceptor 11 is disposed inside the chamber 10 as a stage on which a semiconductor wafer W with a diameter of 300 mm, for example, is mounted. The chamber 10 has an opening for maintenance (not shown) that connects the inside and outside of the chamber 10 and a cover for maintenance (not shown) that can freely open and close the opening for maintenance.

An exhaust passage 12 that functions as a passage that expels gas above the susceptor 11 to outside the chamber 10 is formed between a side wall of the chamber 10 and the susceptor 11. An annular baffle plate 13 is disposed midway inside the exhaust passage 12 and a portion of the exhaust passage 12 downstream of the baffle plate 13 is connected to an automatic pressure control valve (hereinafter simply “APC”) 14 that is a variable butterfly valve. The APC 14 is connected to a turbo-molecular pump (hereinafter simply “TMP”) 15 that is an exhaust pump for creating a vacuum, and is also connected via the TMP 15 to a dry pump (hereinafter simply “DP”) 16 that is also an exhaust pump. An exhaust passage formed by the APC 14, the TMP 15, and the DP 16 will be hereinafter referred to as “the main exhaust line”, with the main exhaust line controlling the pressure inside the chamber 10 using the APC 14 and also reducing the pressure inside the chamber 10 to a near vacuum using the TMP 15 and the DP 16.

Also, the portion of the exhaust passage 12 downstream of the baffle plate 13 is connected to another exhaust passage (hereinafter referred to as “the rough evacuation line”), which is provided in addition to the main exhaust line. The rough evacuation line is comprised of an exhaust pipe 17 that connects the space described above and the DP 16 and has a diameter of 25 mm, for example, and a valve V2 disposed midway across the exhaust pipe 17. The valve V2 can isolate the above downstream portion of the exhaust passage 12 from the DP 16. The rough evacuation line discharges gas from the chamber 10 using the DP 16.

A high-frequency power supply 18 is connected via a power supply rod 40 and a matching box 19 to the susceptor 11, with the high-frequency power supply 18 supplying electric power of a predetermined high frequency to the susceptor 11. By doing so, the susceptor 1.1 functions as a lower electrode. The matching box 19 reduces reflection of high-frequency electric power from the susceptor 11 and thereby maximizes the supply efficiency of the high-frequency electric power to the susceptor 11.

A disc-like electrode plate 20 composed of a conductive film for attracting the semiconductor wafer W using static electricity is disposed at an upper part inside the susceptor 11. The electrode plate 20 is electrically connected to a DC power supply 22. The semiconductor wafer W is held by attraction on an upper surface of the susceptor 11 by a Coulomb's force or a Johnsen-Rahbek force generated by a DC voltage applied to the electrode plate 20 from the DC power supply 22. An annular focus ring 24 made of silicon (Si) or the like is also disposed on an upper part of the susceptor 11 and converges plasma produced above the susceptor 11 toward the semiconductor wafer W.

Inside the susceptor 11 is provided an annular coolant chamber 25 extending along the circumference of the susceptor 11, for example. A coolant, for example, cooling water, at a predetermined temperature is supplied to and circulated in the coolant chamber 25 from a chiller unit (not shown) via piping 26, and the temperature of the susceptor 11 and hence the processing temperature of the semiconductor wafer W held by attraction on the upper surface of the susceptor 11 are controlled through the temperature of this coolant.

A plurality of heat transfer gas supply holes 27 and heat transfer gas supply grooves (not shown) are disposed in a part (hereinafter referred to as the “holding surface”) of the upper surface of the susceptor 11 where the semiconductor wafer W is held by attraction. The heat transfer gas supply holes 27 and the transfer gas supply grooves are connected to a heat transfer gas supply section 29 via a heat transfer gas supply line 28 disposed inside the susceptor 11, with the heat transfer gas supply section 29 supplying heat transfer gas, for example, He gas, to a gap between the holding surface and a rear surface of the semiconductor wafer W. The heat transfer gas supply section 29 is capable of evacuating the gap between the holding surface and the rear surface of the semiconductor wafer W.

Also, a plurality of pusher pins 30 are disposed on the holding surface as lift pins that can protrude from the upper surface of the susceptor 11. The pusher pins 30 are moved up and down as viewed in FIG. 1 as rotational movement of a motor (not shown) is converted into linear movement by a ball screw or the like. When the semiconductor wafer W is held on the holding surface by attraction to carry out an etching process on the semiconductor wafer W, the pusher pins 30 are withdrawn inside the susceptor 11, while when the semiconductor wafer W that has been subjected to the etching process is conveyed from the chamber 10, the pusher pins 30 are moved to protrude from the upper surface of the susceptor 11 to separate the semiconductor wafer W from the susceptor 11 and lift the semiconductor wafer W upward.

A showerhead 33 is disposed in a ceiling portion of the chamber 10. A high-frequency power supply 117 is connected to the showerhead 33 via a matching box 118 and supplies electric power of a predetermined high frequency to the showerhead 33 so that the showerhead 33 functions as an upper electrode. Note that the matching box 118 has the same functions as the matching box 19 described above.

The showerhead 33 includes an electrode plate 35, which has a large number of gas vents 34, disposed on a lower surface thereof, and an electrode support 36 that detachably supports the electrode plate 35. A buffer chamber 37 is provided inside the electrode support 36, and processing gas supply piping 38 extending from a processing gas supply unit (not shown) is connected to the buffer chamber 37. A piping insulator 39 is disposed midway across the gas supply piping 38. The piping insulator 39 is composed of an insulator and prevents the high-frequency electric power supplied to the showerhead 33 from leaking to the processing gas supply unit via the processing gas supply piping 38.

A gate valve 5 is mounted on the side wall of the chamber 10, for opening and closing an inlet/outlet port 31 for the semiconductor wafer W.

As mentioned above, inside the chamber 10 of the plasma processing apparatus 2, high-frequency electric power is supplied to the susceptor 11 and the showerhead 33 so that high-frequency electric power is applied inside the chamber 10 by the susceptor 11 and the showerhead 33, resulting in high-density plasma being produced from the processing gas in the space S between the susceptor 11 and the showerhead 33 and hence ions and radicals being produced.

With this plasma processing apparatus 2, during etching processing, first, the gate valve 5 is opened, and the semiconductor wafer W to be processed is conveyed via the conveying in/out port 31 into the chamber 10, and mounted onto the susceptor 11. A processing gas (e g., a mixed gas comprised of C₄F₈ gas, O₂ gas and Ar gas with a predetermined flow rate ratio therebetween) is introduced at a predetermined flow rate and the predetermined flow rate ratio from the showerhead 33 into the chamber 10, and the pressure inside the chamber 10 is set to a predetermined value using the APC 14 and the like. In addition, high-frequency electric power is applied inside the chamber 10 by the susceptor 11 and the showerhead 33. At this time, the processing gas introduced by the showerhead 33 is converted into plasma as mentioned above. In addition, a DC voltage is applied to the electrode plate 20 by the DC power supply 22 to attract the susceptor 11 to the semiconductor wafer W. The radicals and ions generated by the plasma are converged on the surface of the semiconductor wafer W by the focus ring 24 and hence the surface of the semiconductor wafer W is physically or chemically etched.

As mentioned above with respect to the prior art, ultrasonic sensors are normally used to detect abnormal discharge and in particular arcing that occurs within the chamber 10 and the like. The ultrasonic sensors can detect ultrasonic waves generated inside the chamber 10 and the like. When abnormal discharge occurs, ultrasonic waves are generated due to energy discharge caused by AE. Accordingly, the ultrasonic sensors detect abnormal discharge by detecting ultrasonic waves generated inside the chamber 10.

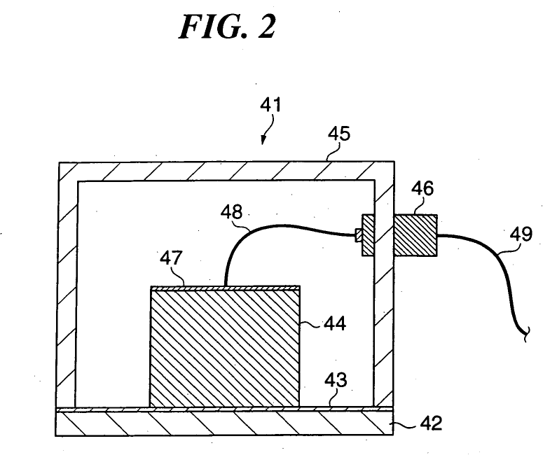

FIG. 2 is a cross-sectional view schematically showing the construction of an ultrasonic sensor connected to the plasma processing apparatus 2 shown in FIG. 1.

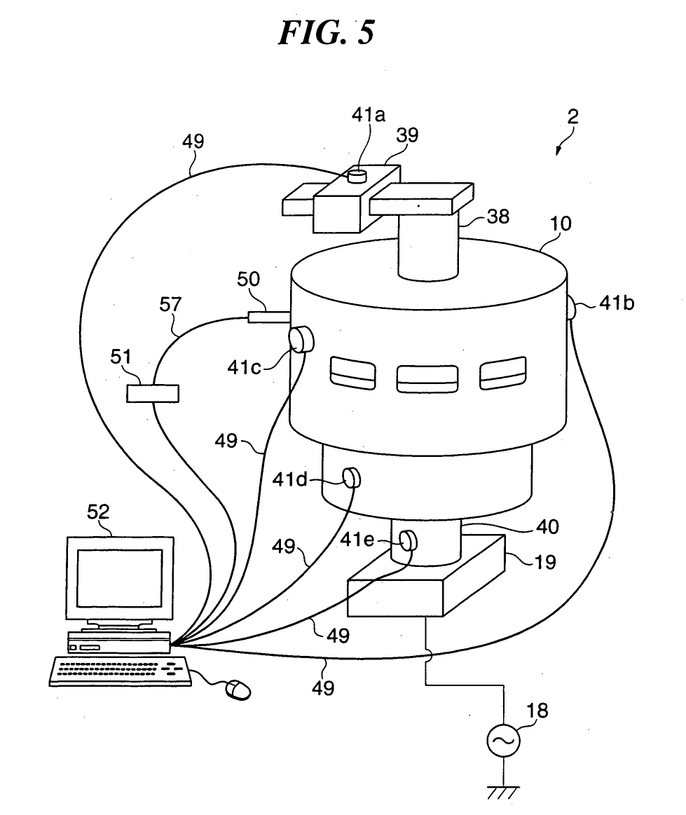

As shown in FIG. 2, the ultrasonic sensor 41 is comprised of a wave-receiving plate 42 in the form of a flat plate made of Al₂O₃, for example, a piezoelectric element (porcelain made of lead zirconate titanate) 44 mounted on the wave-receiving plate 42 via a silver-deposited film 43, a shield case 45 in the form of a housing made of metal, such as aluminum or stainless steel, that is mounted on the wave-receiving plate 42 so as to cover the piezoelectric element 44, a connector 46 that extends through a side wall of the shield case 45, internal wiring 48 that has one end thereof connected via a silver-deposited film 47 to the piezoelectric element 44 and another end thereof connected to a part of the connector 46 that is exposed inside the shield case 45, and external wiring 49 that has one end thereof connected to a part of the connector 46 that is exposed outside the shield case 45 and another end thereof connected to a PC 52 shown in FIG. 5 and described later. The piezoelectric element 44 is a piezoelectric ceramic that expands and contracts when a voltage is applied thereto and, when subjected to a physical vibration such as ultrasonic waves, converts the vibration into a voltage to produce a signal.

As one example, the ultrasonic sensor 41 is mounted on the chamber 10 by tightly attaching the wave-receiving plate 42 to an outside wall of the chamber 10. The ultrasonic sensor 41 is constructed such that ultrasonic waves caused by abnormal discharge inside the chamber 10 that propagate through the outer wall of the chamber 10 are received by the piezoelectric element 44 via the wave-receiving plate 42, the piezoelectric element 44 converts the received ultrasonic waves into a signal, and the signal is transmitted via the internal wiring 48, the connector 46, and the external wiring 49 to the PC 52.

The ultrasonic sensor 41 is mounted on one or more component elements in the plasma processing apparatus 2, for example, on the outside wall of the chamber 10 and/or the piping insulator 39, where abnormal discharge is expected to occur. There is the risk, depending on the component element on which the ultrasonic sensor 41 is mounted, of a leak current flowing from the component element to the ultrasonic sensor 41 and preventing the ultrasonic sensor 41 from correctly detecting abnormal discharge. With the ultrasonic sensor 41, however, the leak current is blocked by the wave-receiving plate 42 that is composed of an insulator, and therefore it is possible for the ultrasonic sensor 41 to correctly detect the abnormal discharge. The insulator used as the wave-receiving plate 42 is not limited to the Al₂O₃ mentioned above, and it is possible to use an insulator that can transmit ultrasonic waves, such as a ceramic like SiO₂, Si alone, or PTFE (polytetrafluoroethylene).

Since the ultrasonic sensor 41 has the construction described above, the ultrasonic sensor 41 detects not only ultrasonic waves caused by abnormal discharge that has occurred inside the chamber 10 but also noise due to mechanical vibration caused by opening and closing of the gate valve 5 and the like. Accordingly, it is necessary to distinguish whether the ultrasonic sensor 41 has detected ultrasonic waves due to abnormal discharge or has detected noise due to mechanical vibration.

To distinguish between ultrasonic waves due to abnormal discharge and noise due to mechanical vibration, it was thought effective to analyze a detection signal from the ultrasonic sensor 41, and therefore the present inventor measured both ultrasonic waves due to abnormal discharge and noise due to mechanical vibration.

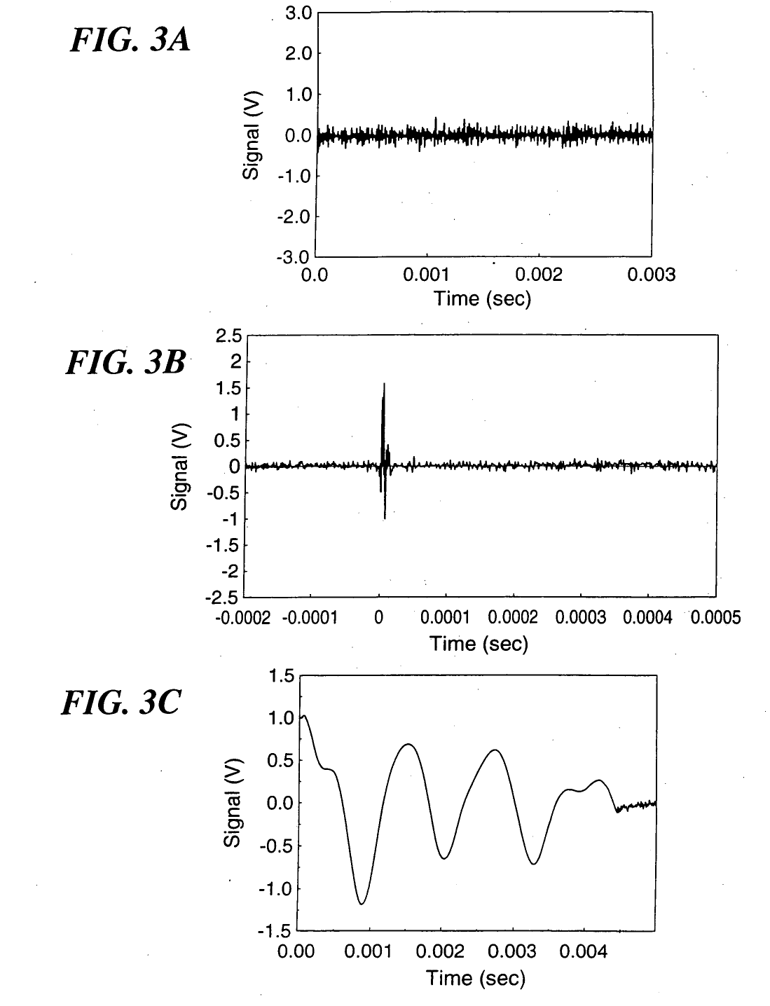

FIGS. 3A to 3C are graphs showing the potential of signals produced by converting ultrasonic waves and noise generated in the plasma processing apparatus 2 and measured by the ultrasonic sensor 41 shown in FIG. 2. FIG. 3A is a graph showing the potential of a signal produced by converting background noise when the plasma processing apparatus 2 shown in FIG. 1 is in a steady state. FIG. 3B is a graph showing the potential of a signal produced by converting abnormal discharge that has occurred in the piping insulator 39 appearing in FIG. 1. FIG. 3C is a graph showing the potential of a signal produced by converting noise due to mechanical vibration caused by the gate valve 5 appearing in FIG. 1 opening and closing. In each of FIGS. 3A to 3C, the abscissa represents time and the ordinate represents the intensity, that is, voltage, of the signal.

By comparing FIG. 3A with FIGS. 3B and 3C, it turned out that a signal with a large amplitude is obtained when abnormal discharge occurs and when noise is produced due to mechanical vibration. However, the amplitudes of the signals in FIGS. 3B and 3C are substantially equal, and hence it turned out that it is not possible to distinguish between ultrasonic waves caused by abnormal discharge and noise due to mechanical vibration by analyzing the amplitude of the signal.

Also, a comparison between FIG. 3B and FIG. 3C showed that the waveforms of the signals and in particular the durations of the signal parts with the largest amplitude differ from each other, and therefore it was thought that it would be possible to distinguish between ultrasonic waves caused by abnormal discharge and noise due to mechanical vibration by analyzing such durations.

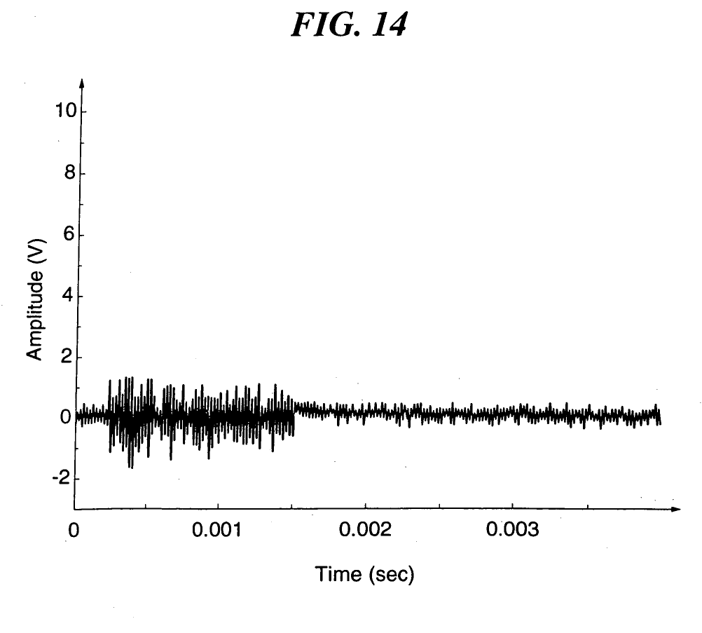

However, on measuring ultrasonic waves caused by abnormal discharge that has occurred inside the chamber 10 (hereinafter referred to as “in-chamber abnormal discharge”) using the ultrasonic sensor 41, the present inventor discovered that as shown in FIG. 14, the duration of the signal parts with the largest amplitude in the signal converted from the ultrasonic waves greatly differs from the duration of the signal parts with the largest amplitude in the signal shown in FIG. 3B. More specifically, it was found that while ultrasonic waves caused by abnormal discharge occurring inside the piping insulator 39 (hereinafter referred to as “in-piping insulator abnormal discharge”) has a pulse-like waveform and only lasts for a short time, ultrasonic waves caused by in-chamber abnormal discharge lasts for a longer time period as shown in FIG. 14 and moreover is sustained in the same way as the ultrasonic waves caused by the opening and closing of the gate valve 5. Accordingly, it was learned that it is not possible to distinguish between ultrasonic waves and noise due to mechanical vibration based on the duration of the signal parts with the largest amplitude in the signal.

The present inventor then hit upon an idea of carrying out frequency analysis on a signal detected by the ultrasonic sensor 41 to distinguish between ultrasonic waves caused by abnormal discharge and noise due to mechanical vibration, and mounted the ultrasonic sensor 41 on the power supply rod 40 and measured ultrasonic waves caused by in-chamber abnormal discharge and noise due to mechanical vibration.

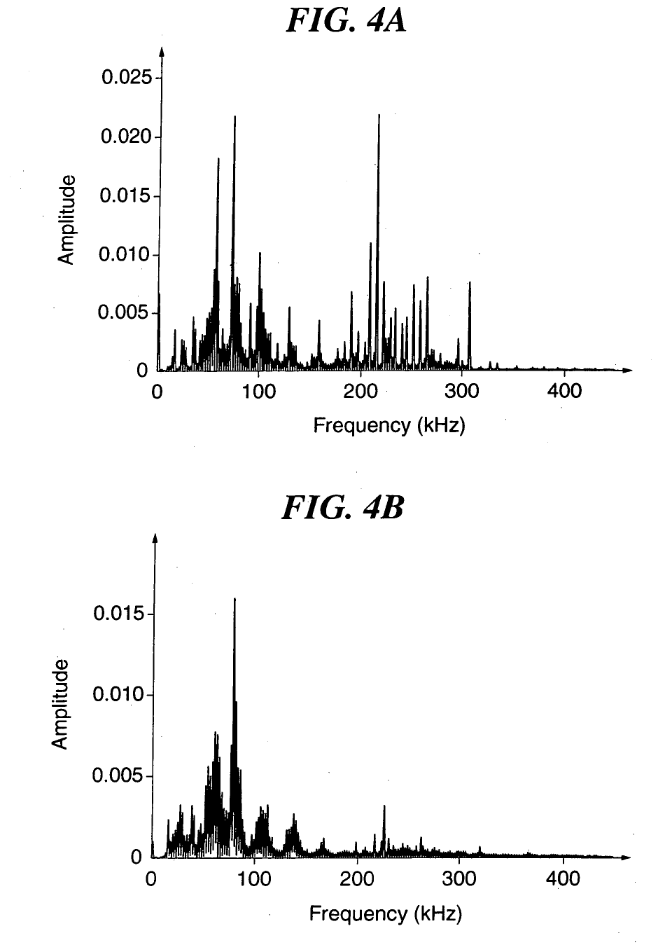

FIG. 4A and FIG. 4B are graphs showing frequency distributions for ultrasonic waves and noise due to mechanical vibration measured by the ultrasonic sensor 41 shown in FIG. 2 that has been mounted on the power supply rod 40 of the plasma processing apparatus 2 shown in FIG. 1. FIG. 4A is a graph showing the frequency distribution for ultrasonic waves caused by abnormal discharge that has been measured by the ultrasonic sensor 41. FIG. 4B is a graph showing the frequency distribution for noise due to mechanical vibration that has been measured by the ultrasonic sensor 41. In FIGS. 4A and 4B, the abscissa represents frequency and the ordinate represents amplitude.

A comparison between FIG. 4A and FIG. 4B showed that the frequency distribution for ultrasonic waves caused by abnormal discharge and that for noise due to mechanical vibration are different from each other. That is, it was learned that while ultrasonic waves caused by abnormal discharge contain high-frequency components of 200 to 300 kHz, noise due to mechanical vibration does not contain such high-frequency components.

However, when the present inventor mounted the ultrasonic sensor 41 on a piping insulator of an atomic layer deposition (ALD) apparatus with a construction that resembles that of the plasma processing apparatus 2, and measured ultrasonic waves caused by in-piping insulator abnormal discharge, it was discovered that the frequency distribution of the measured ultrasonic waves greatly differed from the frequency distribution shown in FIG. 4A. More specifically, it was learned that while the ultrasonic waves caused by in-chamber abnormal discharge shown in FIG. 4A contain high-frequency components, the ultrasonic waves caused by piping insulator abnormal discharge do not contain high-frequency components as is the case with noise due to mechanical vibration. Accordingly, it was understood that it is not possible to distinguish between ultrasonic waves caused by abnormal discharge and noise due to mechanical vibration based on frequency analysis of the signal detected by the ultrasonic sensor 41.

As described above, it was found that the frequency distribution for ultrasonic waves due to abnormal discharge changes in accordance with the positions where the ultrasonic waves are produced and measured in the plasma processing apparatus 2. Although it is difficult to clearly explain the mechanism, from the above comparison results, the present inventor developed the hypothesis described below.

The ultrasonic waves that propagate through the side wall and the like of the chamber 10 are longitudinal vibration waves. If the position at which abnormal discharge occurs and/or the attachment position of the ultrasonic sensor 41 change, the distance from the occurrence position of abnormal discharge to the attachment position of the ultrasonic sensor 41, that is, the characteristic length of the structure that transmits the vibration will change, and accordingly the natural frequency will also change. Also, high-frequency oscillatory waves tend to attenuate inside a solid, and when the distance from the occurrence position of the abnormal discharge to the attachment position of the ultrasonic sensor 41 is long, the high-frequency components in the oscillatory waves will attenuate.

In addition, if the materials of the component elements disposed between the occurrence position of abnormal discharge to the attachment position of the ultrasonic sensor 41 change, the rigidity of the longitudinal vibration transmission system will also change, resulting in a change in the natural frequency. Due to such factors, the frequency distribution of the ultrasonic waves caused by abnormal discharge will change in accordance with the occurrence position and measurement position.

The characteristic length will change when the specification of the plasma processing apparatus 2 changes, for example, when the height of the chamber 10 changes in accordance with changes in the distance between the showerhead 33 and the susceptor 11. Therefore, according to the above hypothesis, the frequency distribution of the ultrasonic waves caused by abnormal discharge will also change when the specification of the plasma processing apparatus 2 changes. This means that an abnormal discharge detecting method based on frequency analysis of the signal detected by an ultrasonic sensor in a given processing apparatus cannot be used for a plasma processing apparatus when for which the specification has been changed or for a plasma processing apparatus with a different specification.

For this reason, the plasma processing apparatus 2 according to the present embodiment includes, in addition to the ultrasonic sensor 41, a potential probe 50 that detects fluctuations in potential.

FIG. 5 is a view showing the arrangement of the ultrasonic sensor 41 and the potential probe 50 installed in the plasma processing apparatus 2 shown in FIG. 1.

As shown in FIG. 5, the plasma processing apparatus 2 is provided with five ultrasonic sensors 41a, 41b, 41c, 41d, and 41e that respectively function as the ultrasonic sensor 41, the signal potential probe 50, and the PC 52 including a CPU.

The ultrasonic sensor 41a is mounted on a side surface of the piping insulator 39, the ultrasonic sensors 41b and 41c are mounted on the outside wall of the chamber 10 at symmetrical positions with respect to the center of the chamber 10, the ultrasonic sensor 41d is mounted on a lower part of the chamber 10, and the ultrasonic sensor 41e is mounted on a power supply rod-fixing jig 62, described later. The potential probe 50 is mounted on the outside wall of the chamber 10.

In the plasma processing apparatus 2, the ultrasonic sensors 41a and 41e are mounted at positions aside from the outside wall of the chamber 10 for the following reasons.

(1) Regarding the Side Wall of the Piping Insulator 39

When high-frequency electric power is applied inside the chamber 10 and plasma ignition occurs to produce plasma, if abnormal discharge occurs inside the processing gas introduction piping 38, component elements on the processing gas introduction piping 38, such as the piping insulator 39, can melt and become damaged. However, since the inside of the processing gas introduction piping 38 is not visible from the outside and there is no maintenance cover as is different from the chamber 10, it is difficult to find damage to such component elements. For this reason, damage to the component elements will proceed, resulting in the component elements being destroyed.

To prevent destruction of the component elements, it is necessary to find damage to the component elements, that is, to detect abnormal discharge. For this reason, in the plasma processing apparatus 2, the ultrasonic sensor 41a is mounted on the side surface of the piping insulator 39.

(2) Regarding the Power supply Rod-Fixing Jig 62

When high-frequency electric power is applied inside the chamber 10 and plasma ignition occurs to produce plasma, abnormal discharge is most likely to occur at or in the vicinity of the susceptor 11 as the lower electrode to which the high-frequency electric power is supplied, and therefore the susceptor 11 is susceptible to electrostatic discharge.

To prevent electrostatic discharge of the susceptor 11, it is necessary to detect ultrasonic waves in the high-frequency electric power supply system that is fixedly connected to the susceptor 11, and hence in the plasma processing apparatus 2, the ultrasonic sensor 41e is mounted on the power supply rod-fixing jig 62 provided on the power supply rod 40 that is a part of the high-frequency power supply system that supplies a high-frequency electric power of several kV to the susceptor 11.

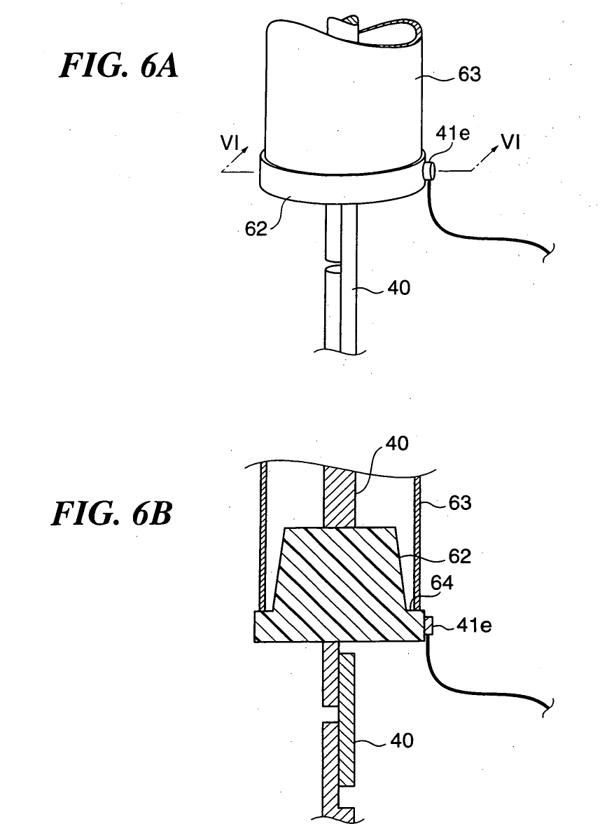

FIGS. 6A and 6B are views showing in detail the construction of the high-frequency power supply system appearing in FIG. 5. FIG. 6A is a perspective view of the high-frequency power supply system and FIG. 6B is a cross-sectional view taken along line VI-VI in FIG. 6A.

As shown in FIGS. 6A and 6B, the power supply rod-fixing jig 62 is disposed on the power supply rod 40 and an insulating cover 63 is disposed on the power supply rod-fixing jig 62 in the figures.

The power supply rod-fixing jig 62 is a generally cylindrical insulating element that is made of PTFE and is tapered with a diameter progressively becoming smaller toward a top thereof. The power supply rod-fixing jig 62 has an engagement hole (not shown) formed therethrough along a central axis thereof, with the power supply rod 40 being inserted through the engagement hole to engage the power supply rod-fixing jig 62. In addition, the power supply rod-fixing jig 62 has a flange portion 64 at a lower part thereof. The ultrasonic sensor 41e is mounted on a side surface of the flange portion 64. The insulating cover 63 is a cylindrical insulating member and a lower end thereof is supported by the flange portion 64 of the power supply rod-fixing jig 62. The insulating cover 63 covers an upper portion of the power supply rod 40 and insulates this portion from the outside.

With the above construction, in the high-frequency electric power supply system, ultrasonic waves caused by abnormal discharge that occurs at or in the vicinity of the susceptor 11 are transmitted to the power supply rod-fixing jig 62 with the power supply rod 40 being insulated from the outside. The ultrasonic sensor 41e detects ultrasonic waves that have propagated to the power supply rod-fixing jig 62.

In the high-frequency electric power system described above, the power supply rod-fixing jig 62 is composed of PTFE, but the material that composes the power supply rod-fixing jig 62 is not limited to this and it is possible to use an insulator that can transmit ultrasonic waves, such as a ceramic like Al₂O₃ or SiO₂, or Si alone.

(3) Regarding the Lower Part of the Chamber 10

The ultrasonic waves caused by abnormal discharge attenuate in amplitude in accordance with the length of the transmission path. Therefore, by disposing the ultrasonic sensor 41d at a position that is far from one occurrence position for abnormal discharge, for example, the piping insulator 39, but close to another occurrence position for abnormal discharge, for example, the susceptor 11, it will be possible to determine at which of the positions abnormal discharge has occurred. That is, when the amplitude of the ultrasonic waves detected by the ultrasonic sensor 41d is smaller than the amplitude of the ultrasonic waves detected by the ultrasonic sensor 41a, for example, it can be determined that abnormal discharge has occurred inside the piping insulator 39, and in the same way, when the amplitude of the ultrasonic waves detected by the ultrasonic sensor 41d is larger, it can be determined that abnormal discharge has occurred at or in the vicinity of the susceptor 11.

Therefore, the ultrasonic sensor 41d is mounted on the lower part of the chamber 10 in the plasma processing apparatus 2.

Since the plasma processing apparatus 2 includes the respective ultrasonic sensors 41 mounted at a plurality of positions where the occurrence of abnormal discharge is expected, it is possible to correctly determine at which position abnormal discharge has occurred. Note that the plasma processing apparatus 2 may alternatively include a single ultrasonic sensor 41. In such case, the ultrasonic sensor 41 should preferably be mounted in the vicinity of the susceptor 11 where abnormal discharge is most likely to occur, for example, on the outside wall of the chamber 10 or in the high-frequency electric power supply system.

Referring again to FIG. 5, in the plasma processing apparatus 2, the respective ultrasonic sensors 41 are connected to the PC 52 by the external wiring 49 and the potential probe 50 is connected to the PC 52 by a conductor 57 via a preamplifier 51 and an amplifier (not shown). The respective ultrasonic sensors 41 convert the detected ultrasonic waves to signals and transmit the signals to the PC 52, and the potential probe 50 converts detected fluctuations in potential to a signal and transmits the signal to the PC 52.

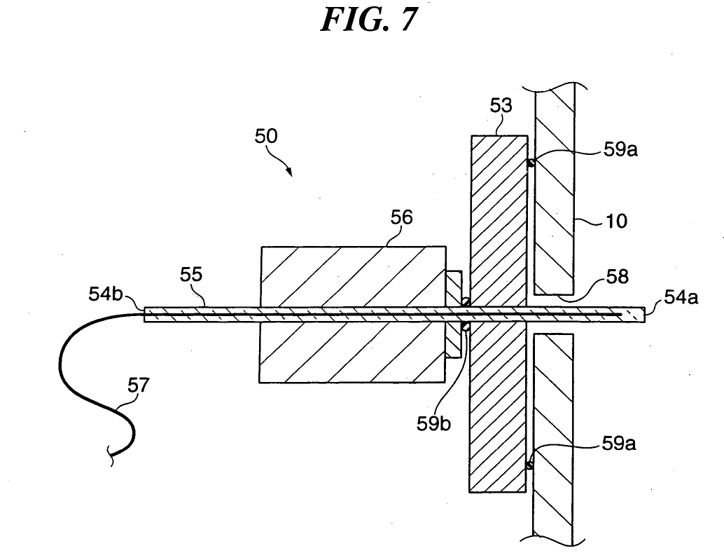

FIG. 7 is a cross-sectional view showing in detail the construction of the potential probe 50 shown in FIG. 5.

As shown in FIG. 7, the potential probe 50 includes an aluminum plate 53 in the form of a flat plate, a quartz tube 55 that has a closed end 54a and an open end 54b and extends through the aluminum plate 53 at right angles thereto, a ferrite core 56 that covers a central portion in the longitudinal direction of the quartz tube 55, and the conductor 57 that is inserted into the quartz tube 55 from the open end 54b thereof and extends to the closed end 54a.

The potential probe 50 is mounted on the outside wall of the chamber 10 so that the closed end 54a of the quartz tube 55 is inserted into a potential fluctuation measuring hole 58 formed in the outside wall of the chamber 10. The amount by which the a portion of the quartz tube 55 toward the closed end 54a protrudes from the aluminum plate 53 is greater than the thickness of the outside wall of the chamber 10 such that the closed end 54a of the quartz tube 55 is exposed inside the chamber 10.

In addition, O-rings 59a, 59b made of heat-resistant rubber such as C-NBR are disposed between the aluminum plate 53 and the outside wall of the chamber 10 and at a position where the quartz tube 55 intersects a surface of the aluminum plate 53 that does not face the outside wall of the chamber 10, and therefore air and the like can be prevented from infiltrating the chamber 10 from the outside.

An induced voltage is generated on a portion of the conductor 57 inside the potential probe 50 mounted on the outside wall of the chamber 10 by fluctuations in potential inside the chamber 10 when high-frequency electric power is applied, and the induced voltage is amplified by the preamplifier 51and the amplifier, and is transmitted to the PC 52 as a signal. In this way, the potential probe 50 detects fluctuations in potential inside the chamber 10. The ferrite core 56 that covers the central portion of the quartz tube 55 removes high-frequency components of the induced voltage that propagates through the conductor 57.

By the way, abnormal discharge is inevitably accompanied by fluctuations in the plasma inside the chamber 10 and the fluctuations in the plasma in turn cause fluctuations in the potential in the vicinity of the inside wall of the chamber 10. Thus, when abnormal discharge occurs, fluctuations in potential will occur in the vicinity of the inside wall of the chamber 10. Here, since the potential probe 50 can detect fluctuations in the potential inside the chamber 10 as mentioned above, it is possible to detect abnormal discharge.

Also, fluctuations in potential inside the chamber 10 do not occur due to noise caused by mechanical vibration, and accordingly the potential probe 50 does not detect noise caused by mechanical vibration. On the other hand, although fluctuations in the potential in the vicinity of the inside wall of the chamber 10 occur when fluctuations occur in the plasma, fluctuations in the plasma do not necessarily cause abnormal discharge, and therefore the potential probe 50 also detects fluctuations in potential caused by fluctuations in the plasma that is not accompanied by abnormal discharge. For this reason, it is not possible to correctly detect abnormal discharge using the potential probe 50 alone. Note that fluctuations in the plasma do not cause emission of energy, and hence ultrasonic waves are not then produced and therefore the ultrasonic sensor 41 cannot detect the fluctuations in the plasma.

In view of the above, in the plasma processing apparatus 2, the CPU of the PC 52 detects abnormal discharge based on the detection result for fluctuations in potential produced by the potential probe 50 and the detection result for ultrasonic waves produced by the ultrasonic sensor 41. Here, since the potential probe 50 does not detect noise caused by mechanical vibration and the ultrasonic sensor 41 does not detect fluctuations in the plasma, it is believed that abnormal discharge has occurred if the ultrasonic sensor 41 detects ultrasonic waves in the same timing as the potential probe 50 detects fluctuations in potential. Therefore, the CPU of the PC 52 determines that abnormal discharge has occurred when the potential probe 50 has detected fluctuations in potential and at the same time the ultrasonic sensor 41 has also detected ultrasonic waves.

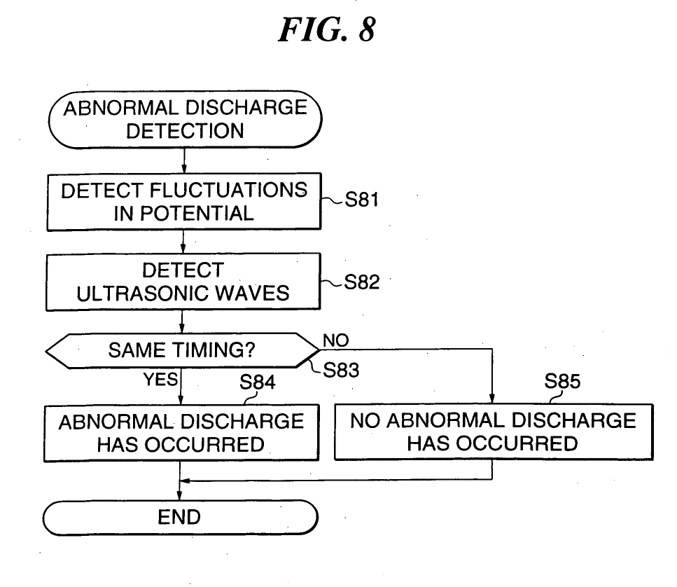

FIG. 8 is a flowchart showing the procedure of an abnormal discharge detecting process carried out by the CPU of the PC 52 appearing in FIG. 5.

In FIG. 8, first, the CPU of the PC 52 receives fluctuations in potential detected by the potential probe 50 as a signal transmitted via the preamplifier 51 and the amplifier (step S81).

The CPU also receives ultrasonic waves detected by the ultrasonic sensor 41 as a signal (step S82).

The CPU determines, based on the signals from the potential probe 50 and the ultrasonic sensor 41, whether ultrasonic waves were detected in the same timing as fluctuations in potential were detected (step S83). On determining that ultrasonic waves were detected in the same timing as fluctuations in potential were detected (“YES” to the step S83), the CPU determines that abnormal discharge has occurred (step S84). Conversely, on determining that ultrasonic waves were not detected in the same timing as fluctuations in potential were detected (“NO” to the step S83), the CPU determines that no abnormal discharge has occurred (step S84), and the present process is terminated.

According to the plasma processing apparatus 2 and the process shown in FIG. 8, when ultrasonic waves are detected by the ultrasonic sensor 41 in the same timing as fluctuations in potential are detected by the potential probe 50, it is determined that abnormal discharge has occurred. Here, fluctuations in potential do not occur due to noise caused by mechanical fluctuations. Therefore, it is possible to distinguish between detection of ultrasonic waves caused by abnormal discharge and detection of noise due to mechanical vibration, thus enabling accurate detection of abnormal discharge. Also, since abnormal discharge can be accurately detected without using frequency analysis on the signal detected by the ultrasonic sensor, it is possible to accurately detect abnormal discharge even for a plasma processing apparatus with a changed specification or a plasma processing apparatus with a different specification, that is, even when the specification of the plasma processing apparatus 2 is changed.

Since in the plasma processing apparatus 2 described above, the ultrasonic sensors 41a, 41b, and 41c are mounted on the side surface of the piping insulator 39 and the outside wall of the chamber 10, it is possible to easily specify the occurrence position of the abnormal discharge. Also, since the ultrasonic sensor 41e is mounted on the power supply rod-fixing jig 62 provided on the power supply rod 40 that is a part of the high-frequency electric power supply system, abnormal discharge that occurs at or in the vicinity of the susceptor 11 can be detected correctly.

In addition, in the plasma processing apparatus 2 described above, by covering the central portion of the quartz tube 55 with the ferrite core 56 in the potential probe 50, high-frequency components in the induced voltage that propagates in the conductor 57 are removed, so that fluctuations in potential due to causes other than fluctuations in the plasma can be removed and therefore abnormal discharge can be detected more accurately.

It should be noted that aside from the outside wall of the chamber 10, the potential probe 50 may be mounted at a desired position in the plasma processing apparatus 2, for example, on the side surface of the piping insulator 39. By doing so, it is possible to correctly detect abnormal discharge that occurs at or in the vicinity of the desired position.

Also, although the ultrasonic sensor 41 and the potential probe 50 are mounted separately in the plasma processing apparatus 2 described above, the ultrasonic sensor and the potential probe may be integrated.

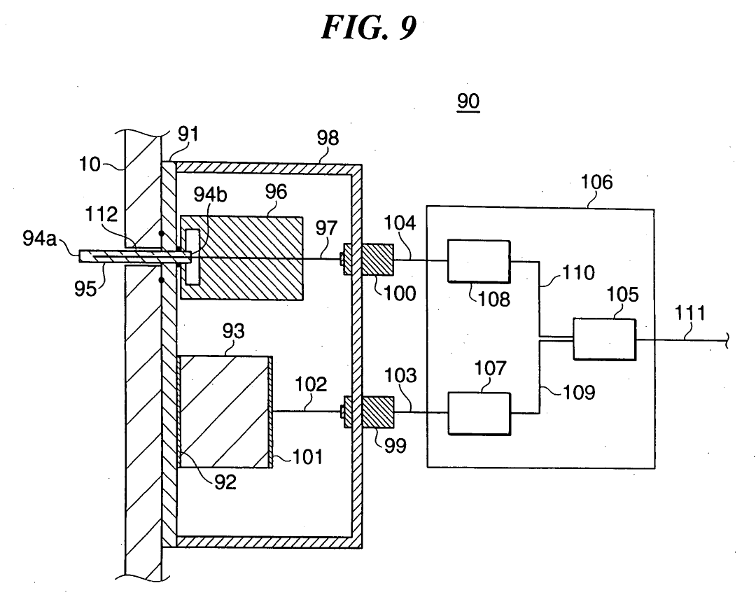

FIG. 9 is a cross-sectional view schematically showing the construction of an integrated abnormal discharge detecting unit in which the ultrasonic sensor and the potential probe shown in FIG. 5 are integrated.

As shown in FIG. 9, the integrated abnormal discharge detecting unit 90 is comprised of a wave-receiving plate 91 in the form of a flat plate composed of an insulator, a piezoelectric element 93 mounted on the wave-receiving plate 91 via a silver-deposited film 92, a quartz tube 95 that has a closed end 94a and an open end 94b and extends through the wave-receiving plate 91 at right angles thereto, a ferrite core 96 that covers the open end 94b of the quartz tube 95, a conductor 97 that extends through the ferrite core 96 and is inserted into the quartz tube 95 from the open end 94b, with one end thereof reaching the closed end 94a, and another end connected to a part of a connector 100, described later, located inside a shield case 98, the shield case 98 in the form of a housing made of metal that is mounted on the wave-receiving plate 91 so as to cover the piezoelectric element 93 and the ferrite core 96, two connectors 99, 100 that extend through a side wall of the shield case 98, internal wiring 10₂ with one end thereof connected to the piezoelectric element 93 via a silver-deposited film 101 and another end connected to a part of the connector 99 inside the shield case 98, and a signal processing section 106.

The signal processing section 106 includes preamplifiers 107, 108, and a synthesis section 105 composed of an AND circuit. The preamplifier 107 is connected by external wiring 103 to a part of the connector 99 outside the shield case 98, the preamplifier 108 is connected by external wiring 104 to a part of the connector 100 outside the shield case 98, the preamplifiers 107 and 108 are respectively connected to the synthesis section 105 by internal wiring 109 and 110, and the synthesis section 105 is connected via external wiring 111 to the PC 52.

The integrated abnormal discharge detecting unit 90 is mounted onto the chamber 10 by inserting the closed end 94a of the quartz tube 95 into a potential fluctuation measuring hole 112 formed in the outside wall of the chamber 10 and tightly fixing the wave-receiving plate 91 to the outside wall of the chamber 10. At this time, the amount by which a part of the quartz tube 95 toward the closed end 94a protrudes from the wave- receiving plate 91 is larger than the thickness of the outside wall of the chamber 10, and hence the closed end 94a of the quartz tube 95 is exposed inside the chamber 10.

In the integrated abnormal discharge detecting unit 90, fluctuations in potential inside the chamber 10 detected by the conductor 97 and the like, are transmitted as a signal via the connector 100, the preamplifier 108, an amplifier (not shown), and a noise filter (not shown) to the synthesis section 105, and ultrasonic waves detected by the piezoelectric element 93 are transmitted as a signal via the connector 99, the preamplifier 107, an amplifier (not shown), and a noise filter (not shown) to the synthesis section 105. Then, the transmitted two types of signals are synthesized by the synthesis section 105 into a composite signal and transmitted to the PC 52. In this way, the integrated abnormal discharge detecting unit 90 detects fluctuations in potential and ultrasonic waves at a single position in the chamber 10. That is, it is possible to detect fluctuations in potential and ultrasonic waves under the same conditions, and consequently abnormal discharge can be detected with even higher accuracy.

It should be noted that the integrated abnormal discharge detecting unit 90 may be mounted at a desired position in the plasma processing apparatus 2, for example, on the side surface of the piping insulator 39. By doing so, it is possible to correctly detect abnormal discharge that occurs at or in the vicinity of the desired position.

Next, a plasma processing apparatus and an abnormal discharge detecting method therefor according to a second embodiment of the present invention will be described.

The construction and operation of the plasma processing apparatus according to the present embodiment are fundamentally the same as those of the plasma processing apparatus 2 according to the first embodiment described above, with the only difference being that the problems that accompany frequency analysis of the signal detected by the ultrasonic sensor 41 are solved using a light-emitting monitor in place of the potential probe 50. Accordingly, duplicated description of the construction and operation is omitted and only the difference in construction and operation will be described below.

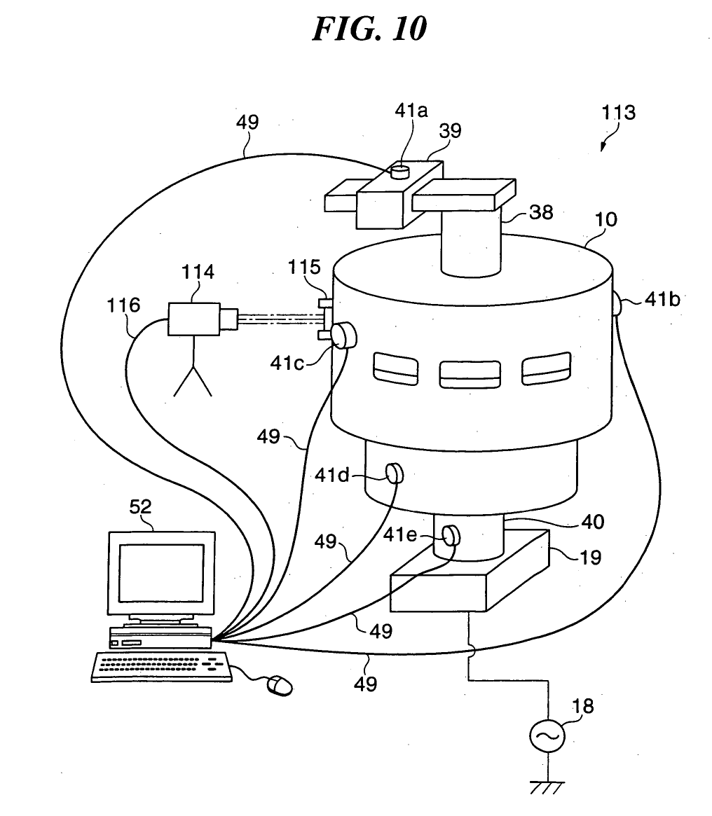

FIG. 10 is a view showing the arrangement of an ultrasonic sensor and a light-emitting monitor mounted on the plasma processing apparatus according to the second embodiment.

As shown in FIG. 10, the plasma processing apparatus 113 is provided with five ultrasonic sensors 41a, 41b, 41c, 41d, and 41e that respectively function as the ultrasonic sensor 41, a single light emission monitor 114 that detects fluctuations in light emission, a light emission monitoring window 115 composed of quartz glass provided in a side wall of the chamber 10, and the PC 52.

The light emission monitoring window 115 is provided at a position where plasma emission light that occurs above the semiconductor wafer W during the etching process inside the chamber 10 can be observed, and the light emission monitor 114 is disposed in facing relation to the light emission monitoring window 115. Accordingly, the light emission monitor 114 can pick up plasma emission light that occurs inside the chamber 10.

In the plasma processing apparatus 113, the respective ultrasonic sensors 41 are connected to the PC 52 by the external wiring 49 and the light emission monitor 114 is connected to the PC 52 via a cable 116. The respective ultrasonic sensors 41 convert the detected ultrasonic waves into signals and transmit the signals to the PC 52 and the light emission monitor 114 converts the picked-up plasma emission light into a signal and transmits the signal to the PC 52.

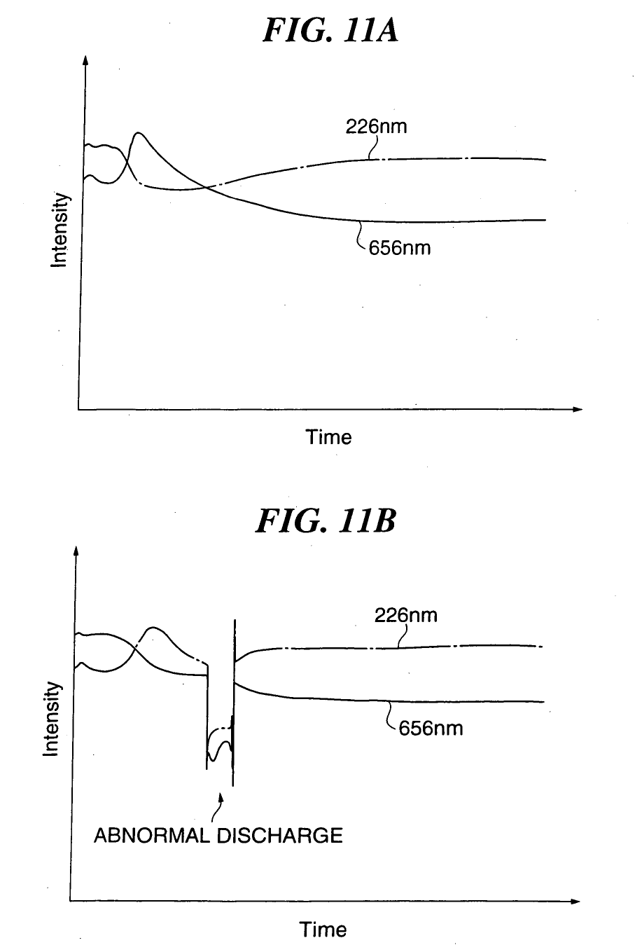

FIGS. 11A and 11B are graphs showing signals converted from the plasma emission light picked up by the light emission monitor 114 appearing in FIG. 10. FIG. 11A is a graph showing the intensity of signals converted from the plasma emission light when the plasma processing apparatus 113 is in a steady state. FIG. 11B is a graph showing the intensity of signals converted from the plasma emission light when abnormal discharge occurs. In FIGS. 11A and 11B, the abscissa represents time and the ordinate represents light emission intensity. Also, in FIGS. 11A and 11B, signals converted from plasma emission light with wavelengths of 226 nm (indicated by one-dot chain lines) and 656 nm (indicated by solid lines) are shown.

By comparing FIGS. 11A and 11B, it will be learned that regardless of the wavelength of the plasma emission light, the light emission intensity undergoes greater fluctuations when abnormal discharge occurs, and in more detail, the light emission intensity falls greatly. Therefore, by picking up the plasma emission light inside the chamber 10, the light emission monitor 114 can detect abnormal discharge.

Also, since the light emission intensity undergoes greater fluctuations when abnormal discharge occurs regardless of the wavelength of the plasma emission light, the plasma emission light picked up by the light emission monitor 114 may have all wavelengths and not simply have a predetermined wavelength. Therefore, the light emission monitor 114 may be configured to detect fluctuations in the total light emission intensity of the plasma emission light, which means that a CCD (Charge Coupled Device) camera or a photo multiplier can be used as the light emission monitor 114, thereby facilitating the detection of fluctuations in the intensity of the plasma emission light.

By the way, since abnormal discharge is inevitably accompanied by fluctuations in the plasma inside the chamber 10 and such fluctuations in the plasma cause changes in the intensity of the plasma emission light inside the chamber 10, when abnormal discharge occurs, fluctuations in the intensity of the light emission occur inside the chamber 10.

Also, since fluctuations in the intensity of the plasma emission light do not occur due to noise caused by mechanical vibration, the light emission monitor 114 does not detect noise caused by mechanical vibration. On the other hand, although fluctuations occur in the intensity of the plasma emission light when fluctuations occurs in the plasma, fluctuations in the plasma do not necessarily cause abnormal discharge, and therefore the light emission monitor 114 also detects fluctuations in the intensity of the plasma emission light due to fluctuations in the plasma that is not accompanied by abnormal discharge. This means that it is not possible to correctly detect abnormal discharge using the light emission monitor 114 alone.

In view of the above, in the plasma processing apparatus 113, the CPU of the PC 52 detects abnormal discharge based on the detection result for fluctuations in plasma emission light produced by the light emission monitor 114 and the detection result for ultrasonic waves produced by the ultrasonic sensor 41. Here, since the light emission monitor 114 does not detect noise due to mechanical vibration and the ultrasonic sensor 41 does not detect fluctuations in the plasma, it is believed that abnormal discharge has occurred if the ultrasonic sensor 41 detects ultrasonic waves in the same timing as the light emission monitor 114 detects fluctuations in the intensity of the plasma emission light. Therefore, the CPU of the PC 52 determines that abnormal discharge has occurred when the light emission monitor 114 has detected fluctuations in the intensity of the plasma emission light and the ultrasonic sensor 41 has also detected ultrasonic waves.

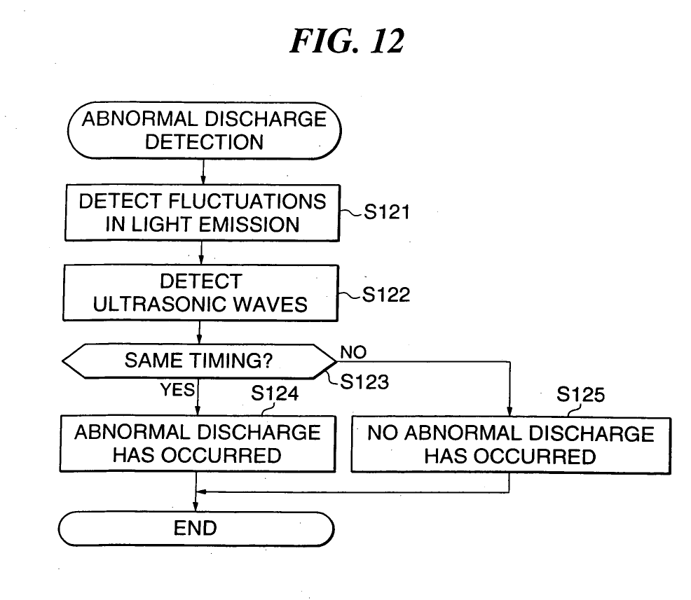

FIG. 12 is a flowchart showing the procedure of an abnormal discharge detecting process carried out by the CPU of the PC 52 appearing in FIG. 10.

In FIG. 12, first, the CPU of the PC 52 receives fluctuations in the intensity of the plasma emission light detected by the light emission monitor 114 as a signal (step S121).

The CPU also receives ultrasonic waves detected by the ultrasonic sensor 41 as a signal (step S122).

The CPU determines, based on the signals from the light emission monitor 114 and the ultrasonic sensor 41, whether ultrasonic waves were detected in the same timing as fluctuations in the intensity of the plasma emission light were detected (step S123). On determining that ultrasonic waves were detected in the same timing as fluctuations in the intensity of the plasma emission light were detected (“YES” to the step S123), the CPU determines that abnormal discharge has occurred (step S124). Conversely, on determining that ultrasonic waves were not detected in the same timing as the fluctuations in the intensity of the plasma emission light were detected (“NO” to the step S123), the CPU determines that no abnormal discharge has occurred (step S125), and the present process is terminated.

According to the plasma processing apparatus 113 and the process shown in FIG. 12, when ultrasonic waves are detected by the ultrasonic sensor 41 in the same timing as fluctuations in the intensity of plasma emission light are detected by the light emission monitor 114, it is determined that abnormal discharge has occurred. Here, fluctuations in the intensity of the plasma emission light do not occur due to noise caused by mechanical fluctuations. Therefore, it is possible to distinguish between detection of ultrasonic waves caused by abnormal discharge and detection of noise due to mechanical vibration, thus enabling accurate detection of abnormal discharge.

According to the embodiments described above, it is possible to accurately detect abnormal discharge. Therefore, when the value of the high-frequency electric power or the pressure inside the chamber 10 has been changed, it is possible to easily detect whether abnormal discharge has occurred, and as a result, it is possible to easily determine process parameters that can prevent damage to the semiconductor wafer W or the component elements and generation of particles. For example, with the plasma processing apparatus 2, although abnormal discharge was detected when a high-frequency electric power of 400 W or above was applied inside the chamber 10 and in particular was frequently detected when a high-frequency electric power of 600 W was applied, no abnormal discharge at all was detected when a high-frequency electric power of 300 W was applied. Therefore, with the plasma processing apparatus 2, the value of the high-frequency electric power should be set at around 400 W.

It is to be understood that the present invention may also be accomplished by supplying a computer, for example the PC 52 or an external server with a storage medium in which a program code of software which realizes the functions of either of the above described embodiments is stored, and causing a CPU of the computer to read out and execute the program code stored in the storage medium.

In this case, the program code itself read out from the storage medium realizes the functions of either of the embodiments described above, and hence the program code and the storage medium in which the program code is stored constitute the present invention.

Examples of the storage medium for supplying the program code include a floppy (registered trademark) disk, a hard disk, a magneto-optical disk, an optical disc such as a CD-ROM, a CD-R, a CD-RW, a DVD-ROM, a DVD-RAM, a DVD-RW, and a DVD+RW, a magnetic tape, a nonvolatile memory card, and a ROM. Alternatively, the program may be downloaded via a network. In this case, the program may be supplied by downloading from another computer, a database, or the like, not shown, connected to the Internet, a commercial network, a local area network, or the like.

Further, it is to be understood that the functions of either of the above described embodiments may be accomplished not only by executing a program code read out by a computer, but also by causing an OS (operating system) or the like which operates on the computer to perform a part or all of the actual operations based on instructions of the program code.

Further, it is to be understood that the functions of either of the above described embodiments may be accomplished by writing a program code read out from the storage medium into a memory provided on an expansion board inserted into the computer or in an expansion unit connected to the computer and then causing a CPU or the like provided in the expansion board or the expansion unit to perform a part or all of the actual operations based on instructions of the program code.

Further, the form of the program code may be an object code, a program code executed by an interpreter, or script data supplied to an OS.

Although in the above described embodiments, a potential probe or a light emission monitor is used together with an ultrasonic sensor as a means for detecting abnormal discharge, the means used together with the ultrasonic sensor for detecting abnormal discharge is not limited to such, and as examples, it is possible to use a current value monitor that measures a value of a current flowing to the susceptor or the electrode plate for attracting the semiconductor wafer W, a reflected wave monitor that measures reflected waves of the high-frequency electric power reflected from the susceptor, or a phase monitor that measures fluctuations in phase of the high-frequency electric power.

Also, although in the above embodiments, the respective plasma processing apparatuses are etching processing apparatuses, the plasma processing apparatus according to the present invention is not limited to such and as examples may be an application/developing apparatus, a substrate washing apparatus, a thermal processing apparatus, or an etching apparatus. Moreover, the respective plasma processing apparatuses may comprise one electrode for applying a high-frequency electric power inside the chamber, for example, may be ICP (inductively coupled plasma) processing apparatuses, or ECR (electron cyclotron resonant plasma) processing apparatuses that use microwave.

In addition, although in the above-described embodiments, the processed substrate is a semiconductor wafer, the processed substrate is not limited to such and may be a glass substrate for LCDs (Liquid Crystal Displays), FPDs (Flat Panel Displays), or the like.

### EXAMPLE

An example of the present invention will now be described in detail.

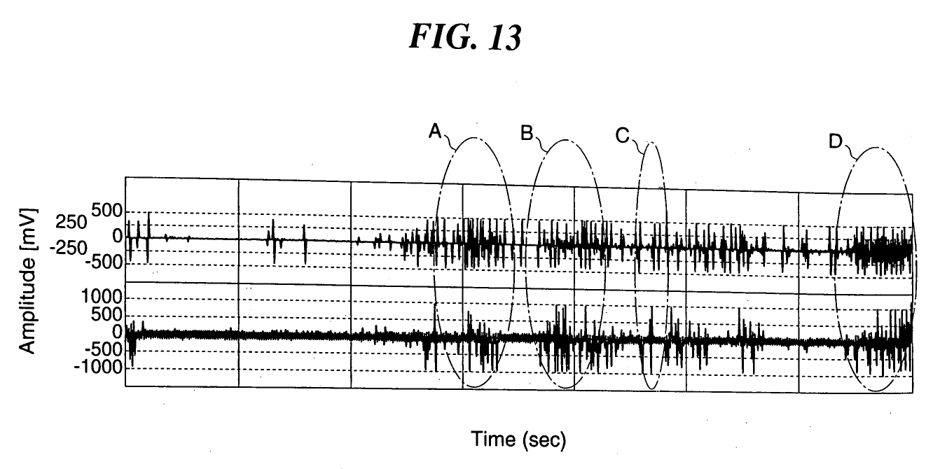

First, fluctuations in potential and ultrasonic waves during an etching process by the plasma processing apparatus 2 were detected. At this time, the occurrence of arcing inside the chamber 10 was visually observed. Signals for the detected fluctuations in potential and ultrasonic waves are shown in a graph of FIG. 13. The timing in which arcing occurred is also shown in the graph in FIG. 13.

In the graph of FIG. 13, the abscissa represents time and the ordinate represents signal amplitude. The upper signal in FIG. 13 is the signal of the ultrasonic waves detected by the ultrasonic sensor 41, and the lower signal is the signal for the fluctuations in potential detected by the potential probe 50.

Next, the process shown in FIG. 8 was carried out by the PC 52 and when ultrasonic waves were detected in the same timing as the fluctuations in potential were detected (time points A to D in FIG. 13), the CPU determines that abnormal discharge has occurred.

As shown in FIG. 13, the time points A to D coincide with the timing in which arcing occurs as shown by ovals. was therefore confirmed that the process shown in FIG. can accurately detect abnormal discharge.

What is claimed is:

1. A plasma processing apparatus comprising:
a chamber that houses a substrate;
at least one electrode that is disposed inside said chamber, for applying a high-frequency electric power inside said chamber;
piping that introduces processing gas into said chamber;
a potential fluctuation detecting device that detects fluctuations in potential;
an ultrasonic detecting device that detects ultrasonic waves; and
an abnormal discharge determining device operable when both the fluctuations in potential and the ultrasonic waves are detected in substantially the same timing, to determine that abnormal discharge has occurred.

2. A plasma processing apparatus according to claim 1, wherein said ultrasonic detecting device comprises a first ultrasonic detecting device disposed on a side surface of said piping, and a second ultrasonic detecting device disposed an outside wall of said chamber.

3. A plasma processing apparatus according to claim 1, further comprising a power supply rod that is connected to said electrode, for supplying the high-frequency electric power to said electrode, and
wherein said ultrasonic detecting device is provided on said power supply rod.

4. A plasma processing apparatus according to claim 1, wherein said potential fluctuation detecting device includes a high-frequency component removing device that removes high-frequency components of a voltage induced by the fluctuations in potential.

5. A plasma processing apparatus according to claim 1, wherein said potential fluctuation detecting device and said ultrasonic detecting device are integrated.

6. A plasma processing apparatus comprising:
a chamber that houses a substrate;
at least one electrode that is disposed inside said chamber, for applying a high-frequency electric power inside said chamber;
piping that introduces processing gas into said chamber;
a light emission fluctuation detecting device that detects fluctuations in intensity of light emission inside said chamber;
an ultrasonic detecting device that detects ultrasonic waves; and
an abnormal discharge determining device operable when both the fluctuations in intensity of light emission and the ultrasonic waves are detected in substantially the same timing, to determine that abnormal discharge has occurred.

7. A plasma processing apparatus according to claim 6, wherein said light emission fluctuation detecting device detects fluctuations in total light emission intensity inside said chamber.

8. An abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the method comprising:
a potential fluctuation detecting step of detecting fluctuations in potential;
an ultrasonic detecting step of detecting ultrasonic waves; and
an abnormal discharge determining step of determining that abnormal discharge has occurred when both the fluctuations in potential and the ultrasonic waves are detected in substantially the same timing.

9. An abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the method comprising:
a light emission fluctuation detecting step of detecting fluctuations in intensity of light emission inside the chamber;
an ultrasonic detecting step of detecting ultrasonic waves; and
an abnormal discharge determining step of determining that abnormal discharge has occurred when both the fluctuations in intensity of light emission and the ultrasonic waves are detected in substantially the same timing.

10. A program for causing a computer to implement an abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the program comprising:
a potential fluctuation detecting module for detecting fluctuations in potential;
an ultrasonic detecting module for detecting ultrasonic waves; and
an abnormal discharge determining module of determining that abnormal discharge has occurred when both the fluctuations in potential and the ultrasonic waves are detected in substantially the same timing.

11. A program for causing a computer to implement an abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the program comprising:
a light emission fluctuation detecting module for detecting fluctuations in intensity of light emission inside the chamber;
an ultrasonic detecting module for detecting ultrasonic waves; and
an abnormal discharge determining module of determining that abnormal discharge has occurred when both the fluctuations in intensity of light emission and the ultrasonic waves are detected in substantially the same timing.

12. A computer-readable storage medium storing a program for causing a computer to implement an abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the program comprising:
a potential fluctuation detecting module for detecting fluctuations in potential;
an ultrasonic detecting module for detecting ultrasonic waves; and
an abnormal discharge determining module of determining-that abnormal discharge has occurred when both the fluctuations in potential and the ultrasonic waves are detected in substantially the same timing.

13. A computer-readable storage medium storing a program for causing a computer to implement an abnormal discharge detecting method for a plasma processing apparatus including a chamber that houses a substrate, at least one electrode that is disposed inside the chamber, for applying a high-frequency electric power inside the chamber, and piping that introduces processing gas into the chamber, the program comprising:
a light emission fluctuation detecting module for detecting fluctuations in intensity of light emission inside the chamber;
an ultrasonic detecting module for detecting ultrasonic waves; and
an abnormal discharge determining module of determining that abnormal discharge has occurred when both the fluctuations in intensity of light emission and the ultrasonic waves are detected in substantially the same timing.
